(19) United States
(12) Patent Application Publication
(10) Pub. No.: US 2024/0175733 A1
(43) Pub. Date: May 30, 2024

(54) METHOD FOR COMMISSIONING A MAGNETIC INDUCTIVE FLOWMETER, AND A MAGNETIC INDUCTIVE FLOWMETER

(71) Applicant: Endress+Hauser Flowtec AG, Reinach (CH)

(72) Inventors: Florent Tschambser, Hesingue (FR); Lars Dreher, Ballrechten Dottingen (DE); Fred Kappertz, Hochwald (CH)

(21) Appl. No.: 18/436,336

(22) Filed: Feb. 8, 2024

Related U.S. Application Data
(63) Continuation of application No. 17/256,485, filed on Dec. 28, 2020.

(30) Foreign Application Priority Data
Jun. 28, 2018 (DE) 10 2018 115 628.6

(51) Int. Cl. G01F 1/60; G01F 1/58

(52) U.S. Cl. CPC G01F 1/60; G01F 1/58

(57) ABSTRACT

Disclosed is a method for commissioning a magneto-inductive flow measuring device having means for producing a magnetic field and at least one measuring electrode pair for sensing a potential difference in a medium. The method includes a settling of the means during a settling time for stabilizing the magnetic field. During the settling time a first voltage time function is applied to the means, wherein after the settling time a measuring time begins, wherein during the measuring time a second voltage time function is applied to the means, wherein the settling time is divided into first time intervals, each of which has a duration, wherein the measuring time is divided into second time intervals, each of which has a duration, wherein an average value of all first interval durations is always less than an average value of all second interval durations.

### CROSS-REFERENCE TO RELATED APPLICATIONS

The present application is a Continuation Application that is related to and claims the priority benefit of U.S. patent application Ser. No. 17/256,485, filed Dec. 28, 2020, German Patent Application No. 10 2018 115 628.6, filed on Jun. 28, 2018, and International Patent Application No. PCT/EP2019/063411, filed on May 23, 2019, the entire contents of which are incorporated herein by reference.

### TECHNICAL FIELD

Magneto-inductive flow measuring devices are applied for determining flow velocity and volume flow of a medium in a measuring tube. A magneto-inductive flow measuring device includes a magnetic field producing means, which forms a magnetic field B extending perpendicularly to the measuring tube axis. Used for such purpose are, usually, one or more coils. In order to implement a predominantly homogeneous magnetic field, supplementally, pole shoes are so formed and applied that the magnetic field lines extend essentially perpendicularly to the measuring tube axis over the total tube cross section. A measuring electrode pair in the wall of the measuring tube senses a potential difference in a direction perpendicularly to the measuring tube axis and perpendicularly to the magnetic field lines. The potential difference arises, when a conductive medium flows in the direction of the measuring tube axis in the presence of an applied magnetic field. Since according to Faraday's law of induction, the sensed potential difference depends on the velocity of the flowing medium, the flow-velocity and, with provision of a known tube cross section, the volume flow of the medium can be ascertained from the potential difference. The potential difference existing between the measuring electrodes is referred to in the following also as measurement voltage.

### BACKGROUND

In order to minimize disturbance effects occurring during a feeding phase, usually a voltage with changing polarity is applied to the magnetic field producing means, i.e. to the components for producing a magnetic field. Another proposal for minimizing disturbance effects is disclosed, for example, in DE 102016124976 A1. This proposes a magneto-inductive flow measuring device, which has between polarity changes a resting phase, in which no electrical voltage is applied to the magnetic field producing means. The characteristic of the disturbance effect arising in the resting phase is measured and used for compensating subsequent disturbance effects. In this way, the magnetic field-end value of the measuring phases can be adapted early. Since, however, the magnetic field-end value varies over a number of periods, this adapting must be performed anew for each resting phase and feeding phase.

EP 0969268 A1 discloses a method for controlling the coil current flowing in a coil arrangement, such that by applying a voltage-beginning value before the voltage-end value, wherein the voltage-beginning value is greater than the voltage-end value, occurring eddy currents are compensated, which delay the rising edge of the magnetic field relative to the coil current. In this way, the magnetic field in each half period reaches the magnetic field-end value sooner.

Disadvantageous in these systems is, however, that, while in a half period the magnetic field-end value is reached or ascertained faster, the end value can change as the number of periods increases, until the end value reaches a global steady state condition value. This behavior can be observed especially directly following commissioning of the flow measuring device. In order to achieve a measurement error of less than 0.2%, the magneto-inductive flow measuring device must be left in operation for a number of days. This is especially problematic for magneto-inductive flow measuring devices, which are adjusted directly after commissioning, since the measurement error then gets built into the adjustments.

### SUMMARY

An object of the present invention is to provide a method for commissioning a magneto-inductive flow measuring device, which method reduces the settling time for reaching steady state, and to provide a magneto-inductive flow measuring device, which performs such method.

The method of the invention for commissioning a magneto-inductive flow measuring device having means for producing a magnetic field B, wherein an electrical voltage U is applied to the means, in order to produce the magnetic field B, and at least one measuring electrode pair for sensing a potential difference in a medium, is characterized by a settling of the means during a

settling time tₐ for stabilizing the magnetic field B until

$$\vert \frac{{B}_{actual} - {B}_{desired}}{{B}_{desired}} \vert < Δ ,$$

wherein Δ is less than 0.25%, and especially less than 0.2% and preferably less than 0.05%, wherein B_{actual} corresponds to a magnetic field-end value of a current, actual state of the magnetic field, wherein B_{desired} corresponds to the magnetic field-end value of a steady state condition of the magnetic field, in which for any B*(t),

$$\vert \frac{{B}^{*} ( t ) - {B}^{*} ( t + 2 k \cdot {t}_{m , j} )}{{B}^{*} ( t )} \vert < 1 / 1000 ,$$

wherein k is a natural number greater than or equal to 1000, wherein during the settling time tₐ a first voltage time function A is applied to the means for producing the magnetic field, wherein after the settling time tₐ a measuring time tₘ begins, wherein during the measuring time tₘ a second voltage time function M is applied to the means for producing the magnetic field, wherein the settling time tₐ is divided into N first time intervals, each of which has a duration t_{a,i} with i ε [1,2, . . . , N], wherein the measuring time tₘ is divided into second time intervals, each of which has a duration t_{m,j} with j ε [symbol] , wherein an average value t̅_̅{̅a̅,̅i̅}̅ of all first interval durations is always less than an average value t̅_̅{̅m̅,̅j̅}̅ of all second interval durations.

During a single feeding phase, the magnetic field as a function of time or the measurement voltage between the measuring electrodes as a function of time is marked by a settling into a local end state at the beginning of the feeding phase, after which the voltage is essentially constant as a function of time. Upon reaching the local end state, the measuring phase begins. Measured values ascertained during the measuring phase are referred to as end values. For determining flow velocity or volume flow, the magnetic field-end value and the measurement voltage-end value of the particular measuring phase are taken into consideration. With the settling of the means for producing a magnetic field into a steady state condition, the local end state converges to a global end state.

After the commissioning of a magneto-inductive flow measuring device, the magnetic field-end value B_{actual} changes over a number of measuring cycles, until it finally, most often after days, converges to a magnetic field-end value B_{desired} of a steady state condition of the magnetic field. This behavior is especially marked in the case of battery-operated magneto-inductive flow measuring devices. Therefore, magneto-inductive flow measuring devices are typically turned-on 30 minutes before the calibrating, whereby a settling of the magnetic field-producing means is assured and the difference between the magnetic field-end value B_{actual} and the steady state magnetic field-end value B_{desired} is reduced. The method of the invention effects a reduction of the waiting time for reaching the steady state magnetic field using an additional settling time ta having a distinctive voltage A as a function of time.

For the producing the voltages A and/or M, preferably electronic components disclosed in EP 0969268 A1 are used.

Advantageous embodiments of the invention are subject matter of the dependent claims.

In an embodiment, the applied electrical voltage U changes sign after each first interval duration t_{a,i} and after each second interval duration t_{m,j}.

It has been found to be advantageous to have the first interval duration t_{a,i} be less than the second interval duration t_{m,j}. Thus, the magnetic field changes sign faster during the settling time tₐ, so that in a short time more energy is introduced into the means for producing the magnetic field. In this way, the means settles faster and the magnetic field-end value B_{actual} achieves the steady state magnetic field-end value B_{desired} sooner.

In an additional embodiment, the second voltage time function M has a third voltage U_{m,shot,i} and/or a fourth voltage U_{m,hold,i}.

In an additional embodiment, the first voltage time function A has a first voltage U_{a,shot,i} and/or a second voltage U_{a,hold,i}.

In an additional embodiment, the first interval duration t_{a,i} is characterized by at least a first time t_{a,shot,i}, in which the first voltage U_{a,shot,i} is applied, and/or at least a second time t_{a,hold,i,} in which the second voltage U_{a,hold} is applied.

It has been found to be advantageous to apply before the measuring time tm a voltage as a function of time known from EP 0969268 A1 having a Uₛₕₒₜ and a U_{hold}, however, with shorter first interval durations t_{a,i}. In this embodiment, the steady-state condition can be achieved sooner, wherein the adapting of the circuit requires only that the length of the interval durations be established anew.

In an additional embodiment, U_{a,shot,i}≥U_{a,hold,i} and t_{a,shot,i}≤t_{a,hold,i}.

In an additional embodiment, U_{a,shot,i}≥U_{a,shot,i+2}, especially U_{a,shot,i}>U_{a,shot,i+2}, wherein t_{a,shot,i}≤t_{a,shot,i+2}.

In an additional embodiment, the i-th first time interval t_{a,i} of the settling time tₐ has features as follows:
a. applying the first voltage U_{a,shot,i} for the first time t_{a,shot,i},
b. applying the second voltage U_{a,hold,i} for the second time t_{a,hold,i},
c. changing the sign of the voltage.

In a modified form of the above mentioned embodiment, the applying of the second voltage U_{a,hold,i} is omitted for the second time t_{a,hold,i}.

In an additional embodiment, the settling time tₐ is less than or equal to 2 h, and especially less than or equal to 30 min and preferably less than or equal to 5 min.

In an additional embodiment, a flow velocity and/or a volume flow of the medium is ascertained based on the potential difference across the measuring electrodes during the measuring time tₘ, especially during the fourth time t_{m,hold,j} and preferably during a measuring phase, in which the magnetic field B is essentially constant.

During polarity change of the voltage applied to the means for producing the magnetic field, disturbance effects occur, so that after each polarity change a certain time needs to be waited, until the magnetic field reaches its local end state. The time period, in which the magnetic field is steady state and essentially constant, is referred to as the measuring phase. It is part of a feeding phase, in which a voltage is applied to the magnetic field producing means. The resulting magnetic field of the measuring phase is referred to as the magnetic field-end value and serves for determining volume flow of the medium. The potential difference on the measuring electrodes during the measuring phase, i.e. the measurement voltage, is referred to as the measurement voltage-end value.

In an additional embodiment, the second interval duration t_{m,j} is composed of at least a third time t_{m,shot,j}, in which the third voltage U_{m,shot,j} is applied, and/or at least a fourth time t_{m,hold,j}, in which the fourth voltage U_{m,hold,j} is applied. Thus, the j-th second time interval of the measuring time tₘ is composed of features as follows:
a. applying the third voltage U_{m,shot,j} for the third time t_{m,shot,j},
b. applying the fourth voltage U_{m,hold,j} for the fourth time t_{m,hold,j},
c. changing the sign of the voltage.

In an additional embodiment, U_{a,shot,i}≥U_{m,shot,j}≥U_{m,hold,j}, especially U_{m,shot,j}>U_{m,hold,j}.

In an additional embodiment, the first voltage U_{a,shot} and the third voltage U_{m,shot,j} have values greater than or equal to 2V, and especially greater than or equal to 12V and preferably greater than or equal to 60V, wherein the second voltage U_{a,hold,i} and the fourth voltage U_{m,hold,j} have values greater than or equal to 0.4V.

In an additional embodiment, a ratio t_{m,j}/t_{a,i} is greater than 2, especially greater than 4 and preferably greater than 8.

A magneto-inductive flow measuring device of the invention includes an operating unit, which is characterized in that it performs the method of the invention for commissioning a magneto-inductive flow measuring device.

### BRIEF DESCRIPTION OF THE DRAWINGS

The invention will now be explained in greater detail based on the appended drawing, the figures of which show as follows:

FIG. 1 shows a schematic view of a magneto-inductive flow measuring device of the state of the art;

FIG. 2 shows a magnetic field-end value B_{actual} as a function of time over a time range of five hours for a conventionally operated magneto-inductive flow measuring device (dotted curve) and a magneto-inductive flow measuring device operated with the method of the present disclosure (solid curve);

U_{m,hold,j}=U_{a,hold,i} FIG. 3 shows by way of example, voltages A and M as functions of time, wherein

U_{m,hold,j}=U_{a,hold,i};

FIG. 4 shows by way of example, voltage A as a function of time and comprising a first voltage U_{a,shot,i}, and voltage M as a function of time and comprising a third voltage U_{m,shot,j} and a fourth voltage U_{m,hold,j}, wherein U_{m,shot,j}=U_{a,shot,i};

FIG. 5 shows by way of example, voltages A and M as functions of time, wherein voltage A comprises the first voltage U_{a,shot,i} and the second voltage U_{a,hold,i}, and voltage M comprises the third voltage U_{m,shot,j} and the fourth voltage U_{m,hold,j}, with U_{a,shot,i}=U_{m,shot,j}, U_{a,hold,i}=U_{m,hold,j} and t_{a,shot,i}=t_{m,shot,j};

FIG. 6 shows by way of example, voltages A and M as functions of time, wherein voltage A comprises the first voltage U_{a,shot,i} and the second voltage U_{a,hold,i}, and voltage M comprises the third voltage U_{m,shot,j} and the fourth voltage U_{m,hold,j}, with variable U_{a,shot,i}, t_{a,shot,i} and t_{a,hold,i}, and with fixed U_{m,shot,j}. In this example, U_{a,hold,i}=U_{m,hold,j}; and

FIG. 7 shows by way of example, voltages A and M as functions of time, comprising variable U_{a,shot,i}, t_{a,shot,i}, t_{a,hold,i} U_{m,shot,j} and t_{m,shot,j} over the course of several first time intervals, wherein U_{a,hold,i}=U_{m,hold,j}.

### DETAILED DESCRIPTION

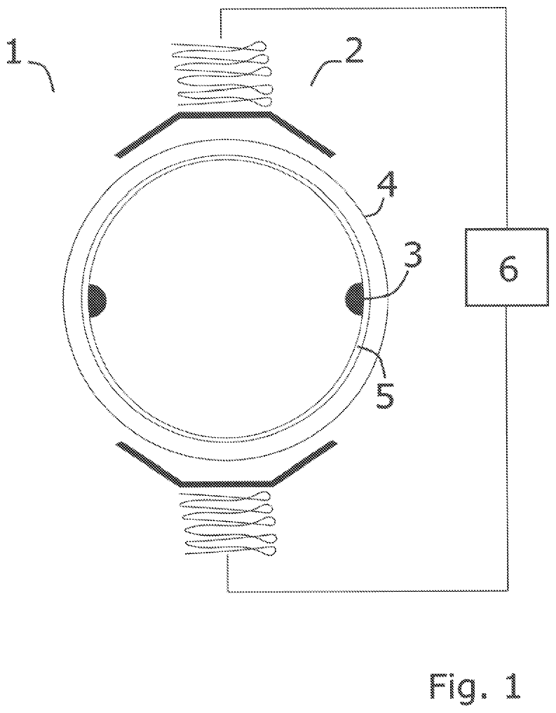

The construction and measuring principle of a magneto-inductive flow measuring device (sec FIG. 1) is basically known. Conveyed through a measuring tube (1) is a medium, which has an electrical conductivity. A magnetic field producing means (2) for producing a magnetic field is so arranged that the magnetic field lines are perpendicular to a longitudinal direction defined by the measuring tube axis. Suited as magnetic field producing means (2) is preferably a saddle coil or a pole shoe with superimposed coil. In the case of applied magnetic field, there arises in the measuring tube (1) a potential difference, which can be sensed with two measuring electrodes (3) provided on the inner surface of the measuring tube. As a rule, these electrodes are diametrally arranged and form an electrode axis, which extends perpendicularly to the magnetic field lines and to the longitudinal direction. Using the measurement voltage sensed by the measuring electrodes, and taking into consideration the magnetic flux density, flow velocity and the tube-cross-sectional area, volume flow of the medium can be determined. For such purpose, the ascertained measurement voltage is evaluated by means of an evaluation unit. In order to avoid corruption of the measurement voltage on the measuring electrodes via a metal tube (4), its inner surface is lined with an insulating material, for example, a liner (5). The magnetic field created by the magnetic field producing means (2) is produced by a clocked, direct current of alternating polarity. This assures a stable zero point and makes the measuring essentially insensitive to influences of multiphase substances, inhomogeneities in the liquid or low conductivity. The voltage applied to the magnetic field producing means is controlled and adjusted via an operating unit (6).

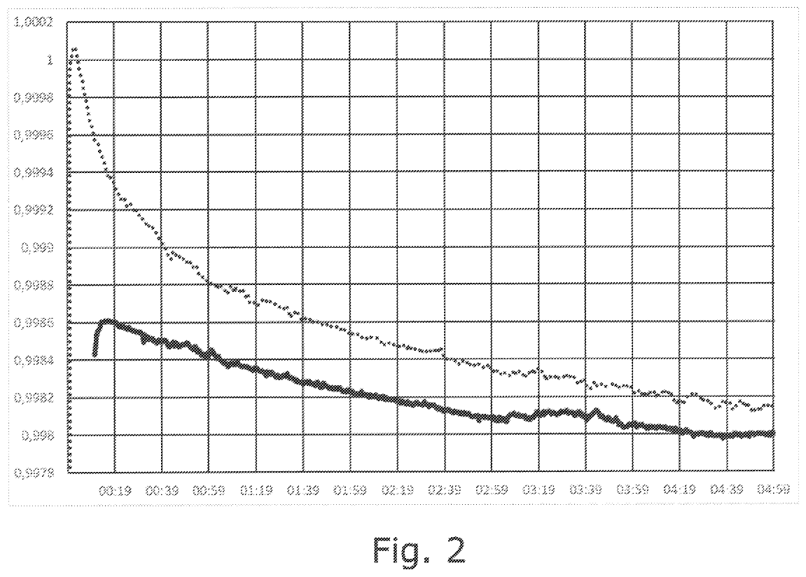

After the commissioning of a magneto-inductive flow measuring device, the magnetic field-end value B_{actual} of the different phases can fluctuate over a number of hours, or a number of days. FIG. 2 shows the relative magnetic field-end value B_{actual} (Y axis) over the course of 5 hours (X axis). The dotted data were taken directly after commissioning of the magneto-inductive flow measuring device and without a settling phase. After commissioning of the magnetic field producing means, the magnetic field-end value measured at the beginning deviates up to 0.2% from the magnetic field-end value ascertained after 5 hours. In such case, the global end state of the magnetic field is still not achieved even after 5 hours. The solid line reflects the data ascertained from a magneto-inductive flow measuring device operated with a ten-minute settling phase. Already at the beginning of the measuring time, the resulting magnetic field-end value Bᵢₛₜ deviates by only 0.06% from magnetic field-end value Bₛₒₗₗ of the steady state condition of the magnetic field.

For ascertaining the magnetic field-end value in FIG. 2, a magnetic field sensor, in this case, a temperature independent pickup-probe, was positioned in the magnetic field center of the magneto-inductive flow measuring device and the resulting magnetic field measured as a function of time. The measurements were performed at room temperature and in the empty state of the measuring tube.

FIG. 3 shows, by way of example, the voltages A and M as functions of time, which last for a settling time tₐ and a measuring time tₘ, respectively In such case, the settling time tₐ is divided into 12 first intervals, each with an interval duration of t_{a,i}. However, also more, or less, than 12 first time intervals can be used. During the first time interval, there is applied to the magnetic field producing means a voltage U, in this case, a second voltage U_{a,hold,i}, whose sign changes at the beginning of each new first time interval (see dotted waveform). The duration of each first time interval is t_{a,i}, which is constant for the entire settling time tₐ in this embodiment. After the settling time tₐ, the measuring time tₘ begins (see dashed curve), which, in turn, is divided into individual, second time intervals with a second interval duration t_{m,j}. During each second time interval, a voltage U, in this case, the fourth voltage U_{m,hold,j}, is applied with alternating sign. FIG. 3 shows that the duration of each second time interval t_{m,j} is constant over the total measuring time tₘ. In such case, according to the invention, the first time interval duration t_{a,i} is less than the second time interval duration t_{m,j}. For the two voltage A and M, U_{a,hold,i}=U_{m,hold,j}.

An advantage of this first embodiment is that the settled state of the magnetic field producing means is reached faster by the shortening of the interval duration during the settling time tₐ. Moreover, conventional electronic circuitry can be used for creating the voltages A and M.

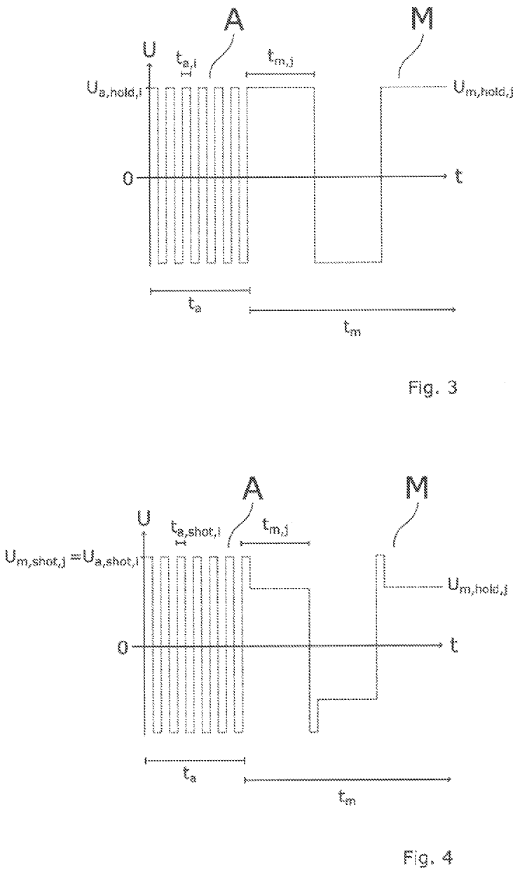

FIG. 4 shows, by way of example, another embodiment of the voltages A and M, which last a settling time tₐ and a measuring time tₘ, respectively. In such case, the settling time ta is divided into 12 first time intervals. However, more, or less, first time intervals can be used. During each first time-interval, a first voltage U_{a,shot,i} is applied (dotted waveform). After the settling time t_{a,} the measuring time tₘ begins, which, in turn, is divided into individual, second time intervals with a second interval duration t_{m,j}. These, in turn, divide, in each case, into a third time t_{m,shot,j}, in which a third voltage U_{m,shot,j} is applied, and a fourth time t_{m,hold,j}, in which a fourth voltage U_{m,hold,j} is applied (see dashed curve). In such case, in this embodiment, the third time t_{m,shot,j} is less than the fourth time t_{m,hold,j} and equals the first time t_{a,shot,i}.

In this second embodiment, the second voltage U_{a,hold,i} is not applied during the settling time tₐ.

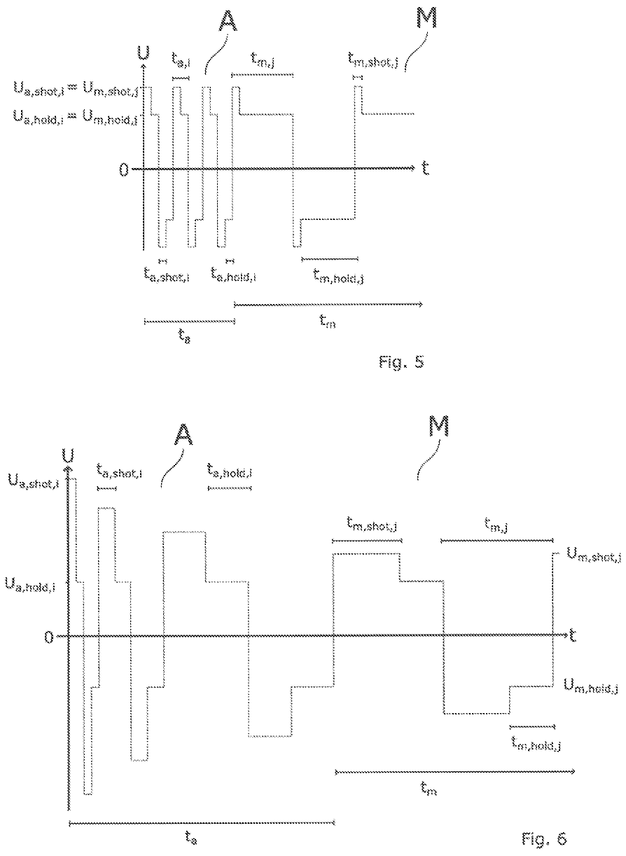

FIG. 5 shows, by way of example, other voltages A and M, which last a settling time tₐ and a measuring time tₘ, respectively. In such case, the settling time tₐ is divided into 6 first time intervals. There can, however, also be more, or less, first time intervals. During each first time interval, a first voltage U_{a,shot,i} is applied for a first time t_{a,shot,i} and a second voltage U_{a,hold,i} for a second time t_{a,hold,i} (see dotted curve). This sequence alternates during the total settling time tₐ. In such case, the first voltage U_{a,shot,i} is always greater than the second voltage U_{a,hold,i}. In this example, the first time t_{a,shot,i} equals the second time t_{a,hold,i}. The sign changes at the beginning of each new first time interval. The first interval duration t_{a,i} is constant for the total settling time tₐ. After the settling time tₐ, the measuring time tₘ begins, which, in turn, is divided into individual, second time intervals with a second interval duration t_{m,j}. This, in turn, is divided, in each case, into a third time t_{m,shot,j}, in which a third voltage U_{m,shot,j} is applied, and a fourth time t_{m,hold,j}, in which a fourth voltage U_{m,hold,j} is applied (see dashed curve). This sequence alternates during the total measuring time tₘ. In such case in this embodiment, the third time t_{m,shot,j} is less than the fourth time t_{m,hold,j} and equals the first time t_{a,shot,i}. FIG. 5 shows that the duration of each second time interval t_{m,j} is the same over the total measuring time tₘ. In such case, according to the invention, the first interval duration t_{a,i} is less than the second interval duration t_{m,j}. In this embodiment, the first voltage U_{a,shot,i} equals the third voltage U_{m,shot,j} and the second voltage U_{a,hold,i} equals the fourth voltage U_{m,hold,j}.

An advantage of this third embodiment is that the magnetic field-end value B_{actual} reaches the steady state magnetic field-end value B_{desired} sooner than in the first embodiment. A similar voltage as a function of time is known from EP 0969268 A1. Such is applied there during the measuring time tₘ. Thus, an electronic circuitry of the same type or the same electronic circuitry can be used for the third embodiment.

FIG. 6 shows an embodiment of other voltages A and M, which last a settling time tₐ and a measuring time tₘ. In such case, the settling time tₐ is divided into 6 first time intervals. There can, however, also be more, or less, first time intervals. During each first time interval, a voltage U_{a,shot,i} and a second voltage U_{a,hold,i} are applied. The first voltage U_{a,shot,i} is greater than the second voltage U_{a,hold,i} and varies over the entire settling time tₐ. The first voltage U_{a,shot,i} is applied for a first time t_{a,shot,i} and the second voltage U_{a,hold,i} directly after the first voltage for a second duration t_{a,hold,i} (see dotted waveform). Both time periods t_{a,shot,i} and t_{a,hold,i} vary over the entire settling time tₐ. The sign of the applied voltage U changes at the beginning of each new first time interval. This sequence alternates during the total settling time tₐ. After the settling time tₐ, the measuring time tₘ begins, which, in turn, is divided into individual, second time intervals t_{m,j}. These, in turn, are divided, in each case, into a third time t_{m,shot,j}, in which a third voltage U_{m,shot,j} is applied, and a fourth time t_{m,hold,j}, in which a fourth voltage U_{m,hold,j} is applied (see dashed curve). This sequence alternates during the total settling time tₘ. In such case, the third time t_{m,shot,j} is always less than or equal to the fourth time t_{m,hold,j}. In this embodiment, the second voltage U_{a,hold,i} equals the fourth voltage U_{m,hold,j} and the first voltage U_{a,shot,i} is greater than or equal to the third voltage U_{m,shot,j}. FIG. 6 shows that the interval durations t_{m,j} are constant over the total measuring time tₘ. In such case, according to the invention, the first interval duration t_{a,i} is less than the second interval duration t_{m,j}.

In an additional form of the fourth embodiment, the first voltage U_{a,shot,i} falls with rising period number, until it assumes the value of the third voltage U_{m,shot,j}. The first duration t_{a,shot,i} depends on the first voltage U_{a,shot,i}. The first duration t_{a,shot,i} falls with increasing first voltage U_{a,shot,i}.

Because U_{a,shot,i}>U_{m,shot,j}, more energy per unit time is supplied to the magnetic field producing means during the settling time than during the measuring time. In this way, the steady-state condition is reached sooner.

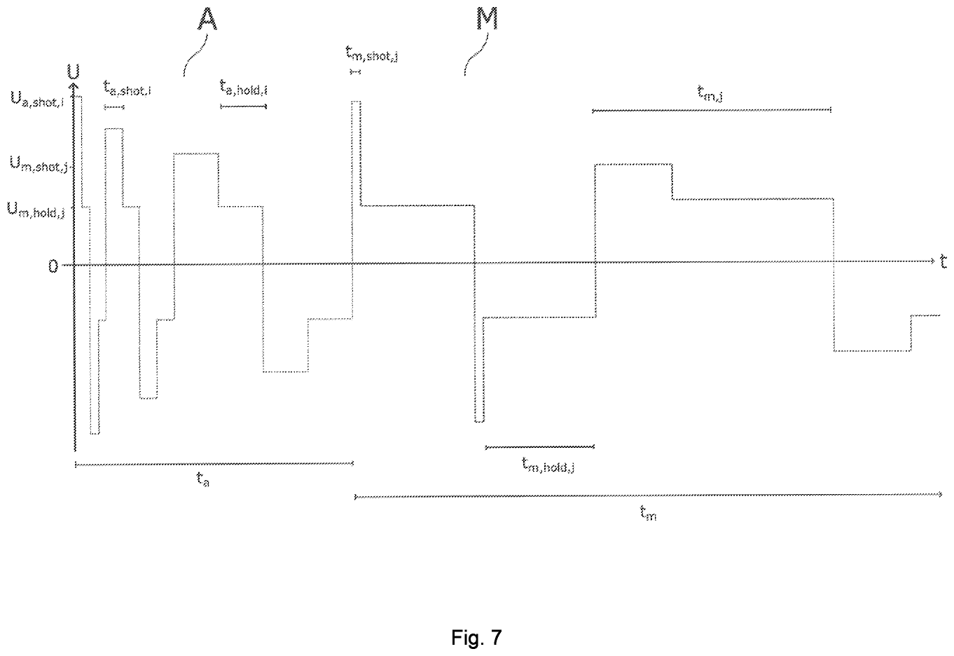

FIG. 7 shows an embodiment of other voltages A and M, which last a settling time tₐ and a measuring time tₘ. In such case, the settling time tₐ is divided into 6 first time intervals, each with an interval duration t_{a,i}. More, or less, first time intervals can be used. During each first time interval, a voltage U_{a,shot,i} and a second voltage U_{m,hold,j} are applied. The first voltage U_{m,shot,j} is greater than the second voltage U_{m,hold,j}. The first voltage U_{a,shot,i} is applied for a first time t_{a,shot,i}, and the second voltage U_{a,hold,i} directly after the first voltage U_{a,shot,i} for a second time t_{a,hold,i} (see dotted curve). Both time periods t_{a,shot,i} and t_{a,hold,i} vary over the entire settling time tₐ. The sign changes at the beginning of each new first time interval. This sequence alternates during the total settling time tₐ. After the settling time tₐ, the measuring time tₘ begins, which, in turn, is divided into individual, second time intervals. These, in turn, divide, in each case, into a third time t_{m,shot,j}, in which a third voltage U_{m,shot,j} is applied, and into a fourth time t_{m,hold,j}, in which a fourth voltage U_{m,hold,j} is applied (see dashed curve). The sign changes at the beginning of each new second time interval. This sequence alternates during the total settling time tₘ. In such case, the third time t_{m,shot,j} is less than the fourth time interval t_{m,hold,j}. In FIG. 7, the second interval duration t_{m,j}, especially the third time t_{m,shot,j} and the fourth time t_{m,hold,j}. varies over the measuring time tₘ. In such case, according to the invention, the first interval duration t_{a,i} is less than the second interval duration t_{m,j}.

In the above embodiments, the second voltage U_{a,hold,i} and fourth voltage U_{m,hold,j} are selected to be constant. The invention is, however, not limited to a constant second voltage U_{a,hold,i} and a constant fourth voltage U_{m,hold,j}. Furthermore, the first, second, third or fourth time do not need to vary over the entire measuring time, or settling time. For example, the settling time tₐ can comprise sequences of time intervals, in which the first voltage U_{a,shot,i} increases or decreases with increasing time interval, and time intervals, in which the first voltage U_{a,shot,i} is constant.

In the embodiments, especially in the voltage functions of time A and M in FIGS. 3 to 7, a voltage is assumed, which is constant over a certain time range. All voltage waveforms represent ideal cases, which only hold, when the electrical resistance of the coils is unchangeable, especially temperature independent. It is known that the coils heat during operation, thereby also changing the electrical resistance of the coils. In order to implement a constant magnetic field, a constant coil current must be assured. This is implemented by adjusting the applied coil voltage in the case of resistance change. It is, for example, known that after heating the coils to ˜90° C. an adjusting of the applied coil voltage by up to 30% from the beginning value can be required.

1. A method for determining a flow velocity and/or a volume flow of a conductive liquid medium, comprising:
providing a magneto-inductive flow measuring device, including:
a means for producing a magnetic field;
an operating unit including a means for applying an electrical voltage to the means for producing the magnetic field to produce the magnetic field; and
a measuring electrode pair for sensing a potential difference in a medium;
applying a first voltage time function to the means for producing the magnetic field, wherein the first voltage time function is applied for a settling time tₐ that is divided into settling time intervals t_{a,i}, wherein the first voltage time function changes sign after each settling time interval t_{a,i}, and wherein the first voltage time function is applied until an end value of the magnetic field differs from a desired value of a steady-state magnetic field by less than 0.25% according to the following inequality:
$$\vert \frac{{B}_{actual} - {B}_{desired}}{{B}_{desired}} \vert < Δ ,$$
wherein Δ is 0.25%, B_{actual} is the magnetic field end value, and B_{desired} is the desired value of the steady-state magnetic field;
applying a second voltage time function to the means for producing the magnetic field, wherein the second voltage time function is applied for a measuring time tₘ that follows the settling time tₐ and that is divided into measuring time intervals t_{m,j}, and wherein the second voltage time function changes sign after each measuring time interval t_{m,j};
measuring, during the measuring time tₘ, a potential difference across the measuring electrodes; and
calculating, during the measuring time tₘ, the flow velocity and/or the volume flow of the conductive liquid medium based on the measured potential difference across the measuring electrodes.

2. The method as claimed in claim 1,
wherein an average value of all settling time intervals t_{a,i} is less than an average value of all measuring time intervals t_{m,j}.

3. The method as claimed in claim 1,
wherein the first voltage time function has a first voltage U_{a,shot,i} and/or a second voltage U_{a,hold,i}, wherein U_{a,shot,i}≥U_{a,hold,i}.

4. The method as claimed in claim 1,
wherein the second voltage time function has a third voltage U_{m,shot,j} and/or a fourth voltage U_{m,hold,j}, wherein U_{m,shot,j}>U_{m,hold,j}.

5. The method as claimed in claim 3,
wherein each settling time interval t_{a,i} includes a first time t_{a,shot,i} in which the first voltage U_{a,shot,i} is applied and/or a second time t_{a,hold,i}, in which the second voltage U_{a,hold,i} is applied, and
wherein t_{a,shot,i}≤t_{a,hold,i}.

6. The method as claimed in claim 4,
wherein each measuring time interval t_{m,j} includes a third time t_{m,shot,j}, in which the third voltage U_{m,shot,j} is applied, and/or a fourth time t_{m,hold,j}, in which the fourth voltage U_{m,hold,j} is applied.

7. The method as claimed in claim 6,
wherein the measuring of the potential difference and the calculating of the flow velocity and/or the volume flow are performed during the fourth time t_{m,hold,j}.

8. The method as claimed in claim 1,
wherein the measuring of the potential difference and the calculating of the flow velocity and/or the volume flow are performed during each measuring time interval t_{m,j}.

9. The method as claimed in claim 1,
wherein a ratio t_{m,j}/t_{a,i} is greater than 2.

10. The method of claim 1,
wherein the steady state condition of the magnetic field is defined according to the inequality:
$$\vert \frac{{B}^{*} ( t ) - {B}^{*} ( t + 2 k \cdot {t}_{m , j} )}{{B}^{*} ( t )} \vert < 1 / 1000 ,$$
wherein B*(t) is a value of the magnetic field as function of time, and k is an integer greater than or equal to 1000.

11. The method as claimed in claim 1,
wherein the first voltage time function has a first voltage U_{a,shot,i} and/or a second voltage U_{a,hold,i}, wherein U_{a,shot,i}≥U_{a,hold,i},
wherein the second voltage time function has a third voltage U_{m,shot,j} and/or a fourth voltage U_{m,hold,j}, wherein U_{m,shot,j}>U_{m,hold,j},
wherein each settling time interval t_{a,i} includes a first time t_{a,shot,i} in which the first voltage U_{a,shot,i} is applied and/or a second time t_{a,hold,i}, in which the second voltage U_{a,hold,i} is applied, wherein t_{a,shot,i}≤t_{a,hold,i},
wherein each measuring time interval t_{m,j} includes a third time t_{m,shot,j} in which the third voltage U_{m,shot,j} is applied and/or a fourth time t_{m,hold,j} in which the fourth voltage U_{m,hold,j} is applied, and
wherein U_{a,shot,i}≥U_{m,shot,j}≥U_{m,hold,j}.

12. The method as claimed in claim 11,
wherein the first voltage U_{a,shot,i} and the third voltage U_{m,shot,j} have values greater than or equal to 2V, and
wherein the second voltage U_{a,hold,i} and the fourth voltage U_{m,hold,j} have values greater than or equal to 0.4V.

13. A magneto-inductive flow measuring device, comprising:
a means for producing a magnetic field;
an operating unit including a means for applying an electrical voltage to the means for producing the magnetic field to produce the magnetic field; and
a measuring electrode pair for sensing a potential difference in a medium,
wherein the operating unit is configured to:
apply a first voltage time function to the means for producing the magnetic field, wherein the first voltage time function is applied for a settling time tₐ that is divided into settling time intervals t_{a,i}, wherein the first voltage time function changes sign after each settling time interval t_{a,i}, and wherein the first voltage time function is applied until an end value of the magnetic field differs from a desired value of a steady-state magnetic field by less than 0.25% according to the following inequality:
$$\vert \frac{{B}_{actual} - {B}_{desired}}{{B}_{desired}} \vert < Δ ,$$
wherein Δ is 0.25%, B_{actual} is the magnetic field end value, and B_{desired} is the desired value of the steady-state magnetic field;
apply a second voltage time function to the means for producing the magnetic field, wherein the second voltage time function is applied for a measuring time tₘ that follows the settling time tₐ and that is divided into measuring time intervals t_{m,j}, and wherein the second voltage time function changes sign after each measuring time interval t_{m,j};
measure, during the measuring time tₘ, a potential difference across the measuring electrodes; and
calculate, during the measuring time tₘ, the flow velocity and/or the volume flow of the conductive liquid medium based on the measured potential difference across the measuring electrodes.

14. The magneto-inductive flow measuring device of claim 13,
wherein the steady state condition of the magnetic field is defined according to the inequality:
$$\vert \frac{{B}^{*} ( t ) - {B}^{*} ( t + 2 k \cdot {t}_{m , j} )}{{B}^{*} ( t )} \vert < 1 / 1000 ,$$
wherein B*(t) is a value of the magnetic field as function of time, k is an integer greater than or equal to 1000, and t_{m,j} is the second time interval.
